(19) United States
(12) Patent Application Publication
(10) Pub. No.: US 2012/0310897 A1
(43) Pub. Date: Dec. 6, 2012

(54) ELECTRONIC DEVICE AND INFORMATION PROCESSING METHOD

(76) Inventor: Jun Sato, Tokyo (JP)

(21) Appl. No.: 13/350,453

(22) Filed: Jan. 13, 2012

(30) Foreign Application Priority Data
May 31, 2011 (JP) 2011-122624

(51) Int. Cl. G06F 7/00

(52) U.S. Cl. 707/687; 707/E17.005

(57) ABSTRACT

According to one embodiment, an electronic device includes: a content processor configured to process content recorded in a recording medium; a first controller configured to, before the content processor terminates processing of the content, perform control such that status information indicating a processing status of the content recorded in the recording medium is changed from first information indicating a processing status of the content before start of the processing performed by the content processor to second information indicating a processing status of the content after termination of the processing performed by the content processor; and a second controller configured to, when the processing of the content performed by the content processor is not normally terminated, perform control such that the status information is changed from the second information to the first information.

### CROSS-REFERENCE TO RELATED APPLICATIONS

This application is based upon and claims the benefit of priority from Japanese Patent Application No. 2011-122624, filed May 31, 2011, the entire contents of which are incorporated herein by reference.

### FIELD

Embodiments described herein relate generally to an electronic device and an information processing method.

### BACKGROUND

Conventionally known are technologies in which, after performing processing, such as reproduction and replication, on content recorded in a recording medium, an electronic device rewrites information indicating a status of the processing of the content (e.g., control information indicating the number of times the content can be reproduced). Also known are technologies in which, before performing processing, such as reproduction and replication, on content recorded in a recording medium, an electronic device rewrites information indicating a status of the processing of the content in advance.

In the case where such an electronic device, after performing processing of content, rewrites information indicating a status of the processing, if some kind of abnormality occurs when the electronic device rewrites the information indicating the status of the processing after terminating the processing, the information indicating the status of the processing may fail to indicate an actual status of the processing accurately.

By contrast, in the case where such an electronic device, before performing processing of content, rewrites information indicating a status of the processing in advance, if some kind of abnormality occurs when the electronic device performs the processing, the information indicating the status of the processing may fail to indicate an actual status of the processing accurately.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a schematic configuration of an electronic device according to an embodiment;

FIG. 2 is an exemplary block diagram of a schematic configuration of a part of the electronic device in the embodiment;

FIG. 3 is an exemplary schematic of a configuration of status information treated by the electronic device in the embodiment;

FIG. 4 is an exemplary block diagram of a schematic configuration of a security module comprised in the electronic device in the embodiment;

FIG. 5 is an exemplary flowchart of processing of content in the electronic device in the embodiment;

FIG. 6 is an exemplary sequence diagram in the case where the processing of the content is normally terminated in the electronic device in the embodiment;

FIG. 7 is an exemplary sequence diagram in the case where the processing of the content is not normally terminated in the electronic device in the embodiment;

FIG. 8 is an exemplary view of information displayed on a display screen during the processing of the content in the electronic device in the embodiment;

FIG. 9 is an exemplary view of information displayed on the display screen when the processing of the content is cancelled in the electronic device in the embodiment;

FIG. 10 is another exemplary sequence diagram in the case where the processing of the content is not normally terminated in the electronic device in the embodiment; and

FIG. 11 is an exemplary flowchart of recovery processing of the status information in the electronic device in the embodiment.

### DETAILED DESCRIPTION

In general, according to one embodiment, an electronic device comprises: content processor, a first controller, and a second controller. The content processor is configured to process content recorded in a recording medium. The first controller is configured to, before the content processor terminates processing of the content, perform control such that status information indicating a processing status of the content recorded in the recording medium is changed from first information indicating a processing status of the content before start of the processing performed by the content processor to second information indicating a processing status of the content after termination of the processing performed by the content processor. The second controller is configured to, when the processing of the content performed by the content processor is not normally terminated, perform control such that the status information is changed from the second information to the first information.

With reference to the accompanying drawings, embodiments of an electronic device and an information processing method will be described in detail below.

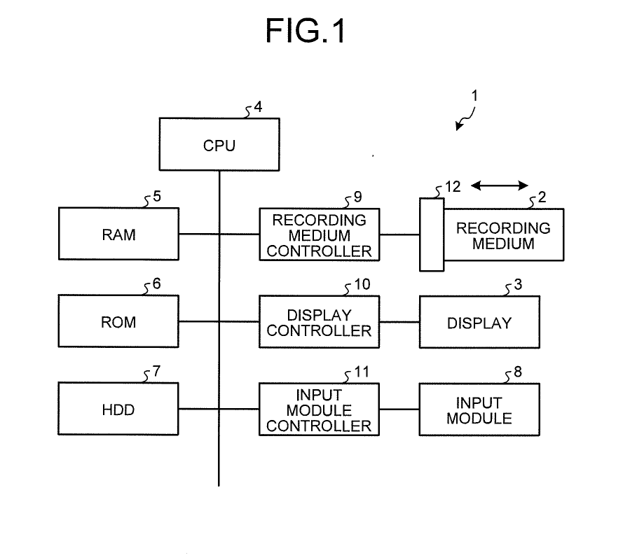

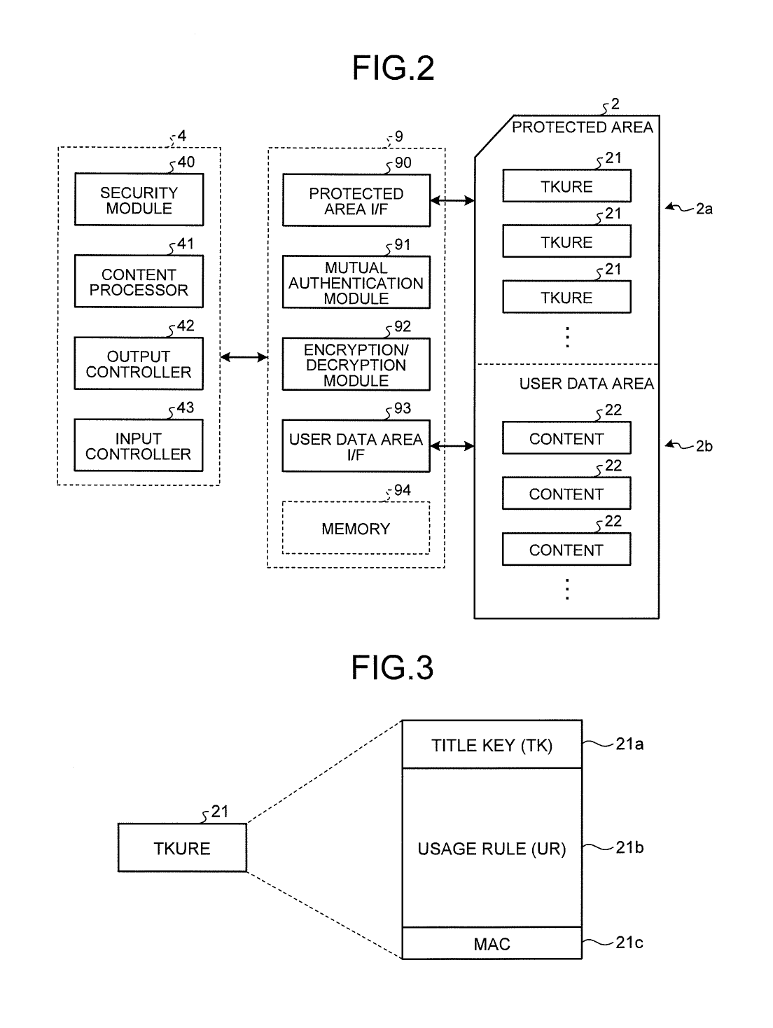

As illustrated in FIG. 1, an electronic device 1 functioning as a host comprises a connector 12 to which a recording medium 2 is detachable. The electronic device 1 can process content 22 (refer to FIG. 2) such as video data (moving image data) and image data (still image data) recorded in the recording medium 2. In the present embodiment, the processing of the content 22 includes reproduction, movement, replication, and deletion.

The electronic device 1 may be, for example, a personal computer, a television receiver, a recorder, a smartphone, and a mobile phone. It is preferable that the electronic device 1 comprise a display 3. However, the electronic device 1 need not necessarily comprise the display 3. The recording medium 2 is a nonvolatile rewritable recording medium (external storage device). The recording medium 2 may be, for example, a memory (a memory card and a universal serial bus (USB) memory), a hard disk drive (HDD), a solid state drive (SSD), a magnetic disk, and an optical disk. Furthermore, the recording medium 2 can be electrically connected to a plurality of electronic devices 1. The recording medium 2 can be retained by the connector 12, or comprise a cable to which a connector (not illustrated) connected to the connector 12 is provided.

As illustrated in FIG. 1, for example, the electronic device 1 that performs processing of the content 22, such as reproduction, movement, replication, and deletion, comprises a central processing unit (CPU) 4, a random access memory (RAM) 5, a read-only memory (ROM) 6, an HDD 7, the display 3, an input module 8, a recording medium controller 9, a display controller 10, and an input module controller 11.

The CPU 4 executes various types of computer programs installed and stored in advance in the ROM 6, the HDD 7, and the like, thereby controlling operations of the modules that constitute the electronic device 1.

The RAM 5 is a rewritable volatile storage device, and functions as a work area of the CPU 4 or the like. Furthermore, during various types of processing, the RAM 5 functions as a stack, a buffer, and the like. The ROM 6 is a non-rewritable nonvolatile storage device, and stores therein the computer programs related to the control of the electronic device 1, various types of setting information, and the like. The HDD 7 is a rewritable nonvolatile storage device, and stores therein the computer programs related to the control of the electronic device 1, various types of data, and the like. The electronic device 1 may comprise a storage device, such as an SSD and a semiconductor memory (e.g., a flash memory), as a rewritable nonvolatile storage device (memory).

The display 3 may be configured as a display device, such as a liquid crystal display (LCD) and an organic electroluminescent display (OELD). The display 3 displays various types of information based on a signal from the CPU 4. The display 3 is driven by the display controller 10.

The input module 8 may be configured as a keyboard, a touch panel, a click button, a push button, and a switch, for example. The input module 8 transmits an instruction signal based on operation input performed by an operator or the like to the CPU 4. The input module controller 11 transmits the signal received from the input module 8 to the CPU 4.

The recording medium controller 9 is arranged between the CPU 4 and the recording medium 2. The recording medium controller 9, for example, performs a part of the processing of the content 22 in the recording medium 2, and receives and transmits data from and to the recording medium 2.

FIG. 2 illustrates an example of a functional block related to the processing of the content 22 performed in the electronic device 1 according to the present embodiment. In the present embodiment, for example, the CPU 4 comprises a security module 40, a content processor 41, an output controller 42, and an input controller 43. The recording medium controller 9 comprises a protected area interface (I/F) 90, a mutual authentication module 91, an encryption/decryption module 92, and a user data area I/F 93.

The CPU 4 executes a computer program stored in a nonvolatile storage device, such as the ROM 6 and the HDD 7, thereby functioning as the functional blocks described above (in the present embodiment, for example, as the security module 40, the content processor 41, the output controller 42, and the input controller 43). In other words, the computer program contains modules by which the CPU 4 functions as the functional blocks described above. Note that the arrangement of the functional blocks illustrated in FIG. 2 is just an example, and may be other arrangements. The mutual authentication module 91 and the encryption/decryption module 92, for example, can be implemented as hardware in another chip other than the recording medium controller 9, or can be implemented as software in the CPU 4.

As illustrated in FIG. 2, for example, the recording medium 2 comprises two areas of a protected area 2a and a user data area 2b. The user data area 2b is an area accessible by a normal process of read/write. The user data area 2b stores therein the contents 22, metadata thereof, and the like. It is preferable that the content 22 be encrypted. By contrast, the protected area 2a is an area accessible by permission in a mutual authentication process performed by the mutual authentication module 91. The protected area 2a stores therein data 21 corresponding to each of the contents 22 in the user data area 2b. Note that the data 21 is represented as TKURE for convenience so as to be distinguished from other data in the drawings.

The data 21 contains a title key (TK) 21a, a usage rule (UR) 21b, and a message authentication code (MAC) 21c, for example. The TK 21a is a cryptographic key of the content 22 thus encrypted, and is a key unique to each of the contents 22. The title key 21a is a 128-bit length cryptographic key, and can be encrypted by a media unique key, for example. As the encryption method in this case, for example, an electronic codebook (ECB) mode of the advanced encryption standard (AES) can be employed, for example.

The UR 21b can contain control information for each processing aspect of the content 22 corresponding thereto (e.g., control information for the number of times of reproduction, control information for validity period setting, control information for the number of times of movement, control information for the number of times of replication, and control information for the number of times of lending), and other pieces of information. Each piece of the control information, for example, can contain the total number of times of the processing of the content 22 (e.g., the number of times the content 22 can be processed: 10 times), the current number of times already used (e.g., the number of times the content 22 is processed: once), and the current number of times yet to be used (e.g., the number of times the content 22 is to be processed: nine times). The UR 21b (control information) is an example of status information.

The MAC 21c is a digest for detecting falsification of the UR 21b, and is a hash generated by using the TK 21a as a key, for example. By a cipher-based MAC (CMAC) method, for example, the MAC 21c can be generated and verified. By using the MAC 21c, it is possible to verify a combination of the TK 21a and the UR 21b. If either of the TK 21a or the UR 21b is falsified, a MAC thus generated is not identical to the stored MAC 21c. In this case, the electronic device 1 does not perform processing of the content 22 corresponding to the data 21.

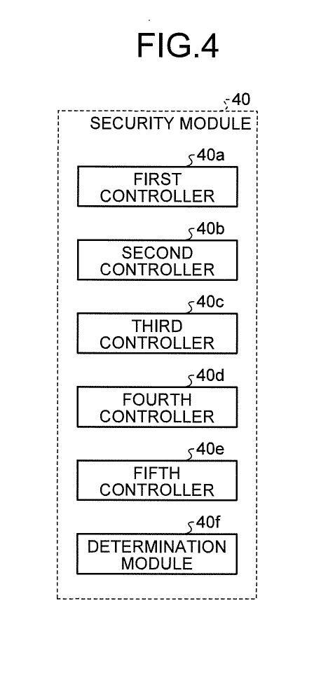

Furthermore, as illustrated in FIG. 4, the security module 40 comprises functional blocks of a first controller 40a, a second controller 40b, a third controller 40c, a fourth controller 40d, a fifth controller 40e, and a determination module 40f. Note that FIG. 4 illustrates a part of the functional blocks (modules) of the security module 40. Functions and operations of each of the functional blocks will be described later.

An explanation will be made of an example of operations of the modules at a stage before the processing (preprocessing) of the content 22 in the electronic device 1 serving as the host. In a state where the recording medium 2 is connected to the electronic device 1, the content processor 41 accesses the user data area 2b of the recording medium 2 via the user data area I/F 93. The content processor 41 acquires meta-information corresponding to each of the contents 22 from the user data area 2b. Subsequently, the output controller 42 controls the display controller 10 such that the display 3 displays information of the content 22 based on the meta-information. The operator (user) operates the input module 8 based on the information (not illustrated) displayed on a display screen (not illustrated) of the display 3, and performs operation input for instructing (selecting or specifying) the processing of the content 22 to be performed. The input controller 43 acquires data (signal) corresponding to the input operation of the input module 8 performed by the operator via the input module controller 11. The data thus acquired causes the content processor 41 to determine the content 22 to be processed and the processing (reproduction, movement, replication, deletion, or the like) performed on the content 22.

The content processor 41 accesses the content 22 to be processed that is selected by the operator via the user data area I/F 93, and acquires data indicating the data 21 corresponding to the content 22 (data capable of identifying the data 21). The data allows the security module 40 to identify the data 21 corresponding to the content 22 to be processed.

Prior to the processing of the content 22, the mutual authentication module 91 performs a mutual authentication process between the electronic device 1 and the recording medium 2 by a known method. The encryption/decryption module 92 performs encryption processing required for the mutual authentication process. Furthermore, the mutual authentication module 91 generates a media unique key in the mutual authentication process. If no problem occurs in the mutual authentication process, the protected area I/F 90 performs access processing of a required file system. The protected area I/F 90 then acquires the data 21 to be a target, and transmits the data 21 to the security module 40.

When receiving the data 21, the security module 40 decrypts the TK 21a by using the media unique key generated by the mutual authentication module 91. Subsequently, the security module 40 generates a MAC by using the TK 21a thus decrypted and the UR 21b. The security module 40 then compares the MAC thus generated with the MAC 21c contained in the data 21. If both of the two MACs are identical to each other, requested processing of the content 22 described below is performed.

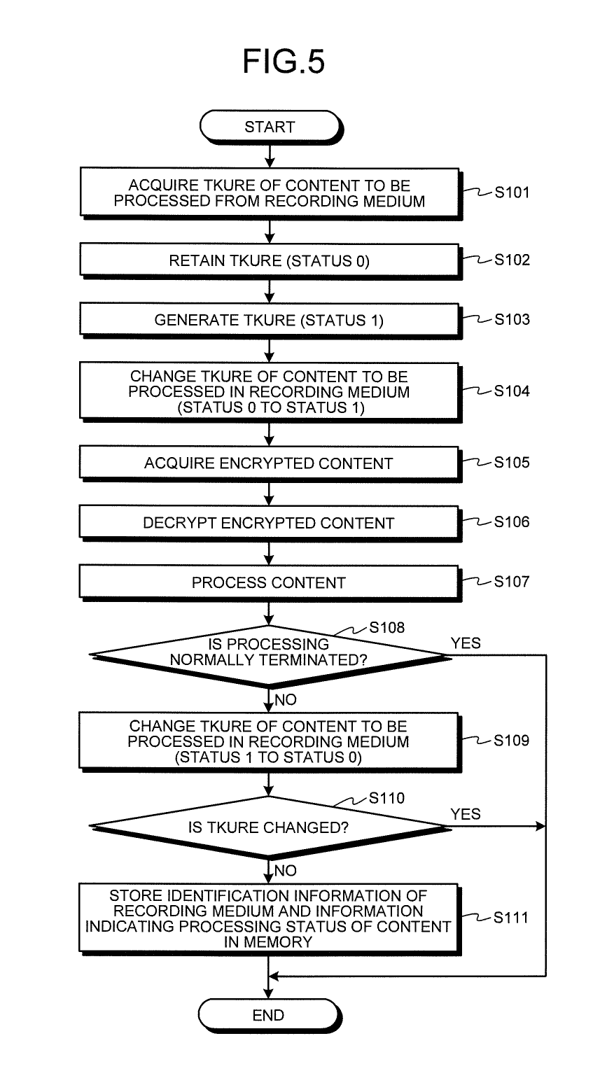

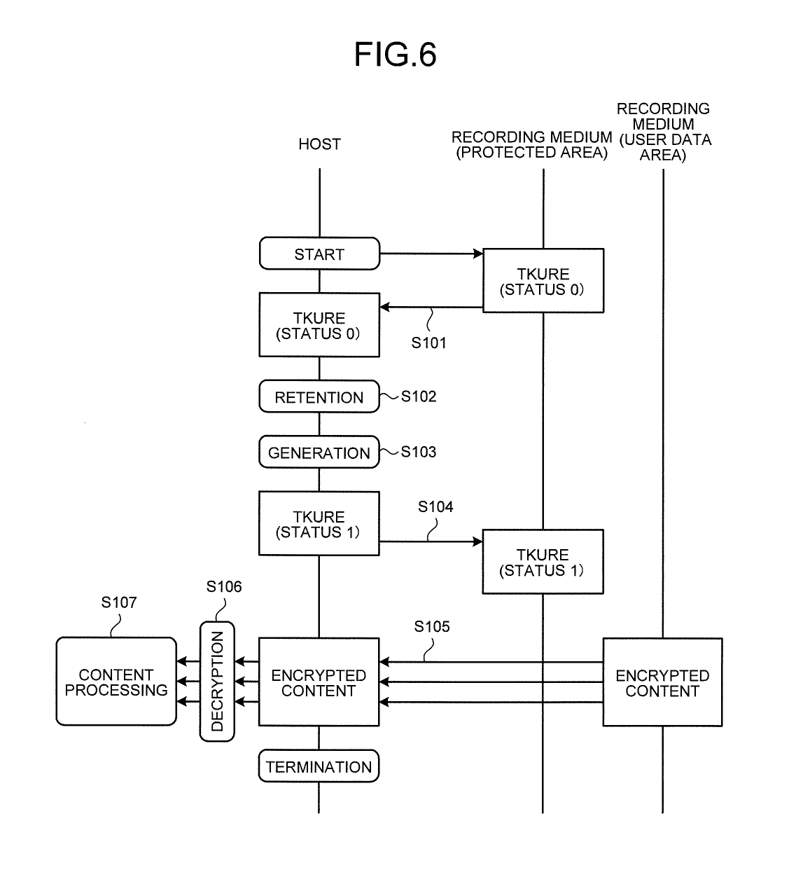

An example of the processing of the content 22 will now be described with reference to FIGS. 5 and 6. The security module 40 acquires the data (TKURE) 21 corresponding to the content 22 to be processed from the recording medium 2 via the protected area I/F 90 (S101). The UR 21b in the data 21 contains the control information described above. The processing status of the content 22 indicated by the control information in the data 21 acquired at S101 is defined to be “status 0” for convenience. In other words, the control information of “status 0” indicates the processing status of the content 22 before the processing of the content 22 is started. The UR 21b (data 21) containing the control information of “status 0” is an example of the status information and an example of first information.

When S101 is performed, the security module 40 can refer to the control information to determine whether the requested processing of the content 22 can be performed. In the state where “reproduction” of the content 22 is requested, for example, if the number of times the content 22 can be reproduced in the control information for the number of times of reproduction is “0”, the security module 40 determines that the processing of the content 22 cannot be performed. In this case, the output controller 42 controls the display controller 10 such that the display 3 displays information (e.g., characters and images) indicating that the requested processing of the content 22 cannot be performed. The security module 40 and the content processor 41 do not perform the requested processing of the content 22.

If the processing of the content 22 can be performed, after S101, the security module 40 retains the control information of “status 0” acquired from the recording medium 2 in a predetermined memory (e.g., an example of a volatile memory or an information storage, such as the RAM 5 and a cache, which is not illustrated) (S102). Subsequently, the security module 40 generates control information of “status 1” indicating the processing status after the requested processing of the content 22 is terminated (S103). The status after the requested processing of the content 22 is performed is defined to be “status 1” for convenience. In other words, the control information of “status 1” indicates the processing status of the content 22 after the requested processing of the content 22 is performed. Specifically, at S103, if the number of times the content 22 can be reproduced in the control information (control information for the number of times of reproduction) of “status 0” is “5”, and if the requested processing of the content 22 is “reproduction”, for example, the security module 40 generates control information (control information for the number of times of reproduction) of “status 1” in which the number of times the content 22 can be performed is “4”. The UR 21b (data 21) containing the control information of “status 1” is an example of the status information and an example of second information. The control information of “status 0” and the control information of “status 1” thus generated is retained in the predetermined memory until the processing of the content 22 is terminated. When the processing of the content 22 is terminated, the control information of “status 0” and the control information of “status 1” is discarded (deleted) regardless of normal termination or abnormal termination.

Subsequently, the first controller 40a of the security module 40 controls the protected area I/F 90 such that the control information of the UR 21b in the data 21 corresponding to the content 22 to be processed is changed from the control information of “status 0” to the control information of “status 1” (S104, and an example of a second step). By S104, the control information (status information) of the UR 21b in the data 21 corresponding to the content 22 to be processed is changed, before the processing of the content 22 is terminated (in the present embodiment, before the processing of the content 22 is started), from the information (first information) indicating the status before the processing of the content 22 is started to the information (second information) indicating the status after the processing of the content 22 is terminated.

Subsequently, the content processor 41 acquires the encrypted content 22 from the recording medium 2 via the user data area I/F 93 (S105). The encryption/decryption module 92 decrypts the encrypted content 22 (S106). At S106, the encryption/decryption module 92 decrypts the encrypted content 22 by using the TK 21a. Subsequently, the content processor 41 controls the modules such that the requested processing of the content 22 is performed. (S107, and an example of a first step). Specifically, at S107, if reproduction of the content 22 is requested, for example, the content processor 41 controls the output controller 42, the display controller 10, a controller for a speaker (not illustrated), and the like such that the display screen (not illustrated) of the display 3 displays a video image of the content 22, and the speaker, which is not illustrated, outputs a sound of the content 22.

The security module 40 monitors the processing status of the content 22 (S108). If the requested processing is normally terminated (Yes at S108), the security module 40 terminates the processing of the content 22. FIG. 6 illustrates an example of a sequence diagram when the processing is normally terminated.

By contrast, if the processing of the content 22 is not normally terminated, that is, if the processing of the content 22 is interrupted because of some kind of abnormality or other factors, and fails to be resumed (No at S108), the second controller 40b of the security module 40 controls the protected area I/F 90 such that the control information of the UR 21b in the data 21 corresponding to the content 22 to be processed is changed from the control information of “status 1” to the control information of “status 0” (S109, and an example of a third step). By S109, the control information (status information) of the UR 21b in the data 21 corresponding to the content 22 to be processed is changed from the information (second information) indicating the status after the processing of the content 22 is terminated to the information (first information) indicating the status before the processing of the content 22 is started. If the control information of the UR 21b in the data 21 corresponding to the content 22 to be processed can be changed (Yes at S110), the series of processing of the content 22 is terminated. The case in which the processing of the content 22 is not normally terminated (is abnormally terminated) includes: the case in which the operator (user) cancels the processing of the content 22; the case in which, in replication (copy) or movement of the content 22, the contents 22 fails to be moved or replicated because of a small storage capacity of a destination to which the content 22 is replicated or moved; the case in which an interrupt signal that interrupts the processing of the content 22 is received; and the case in which data fails to be transferred between the electronic device 1 and the recording medium 2 because of removal of the recording medium 2 from the connector 12 or other factors.

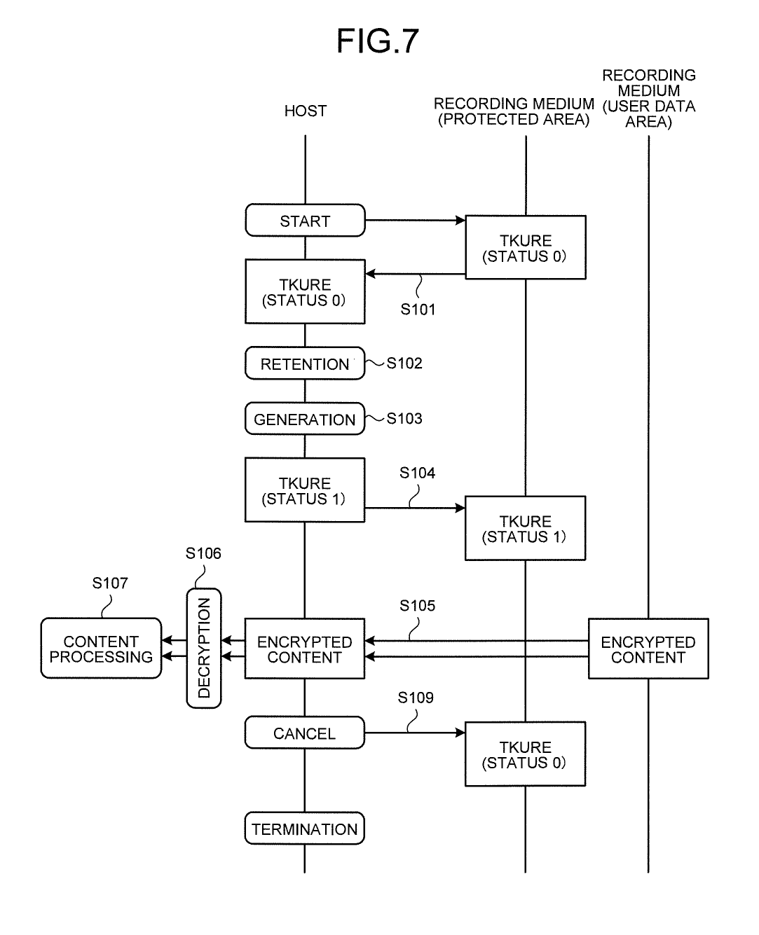

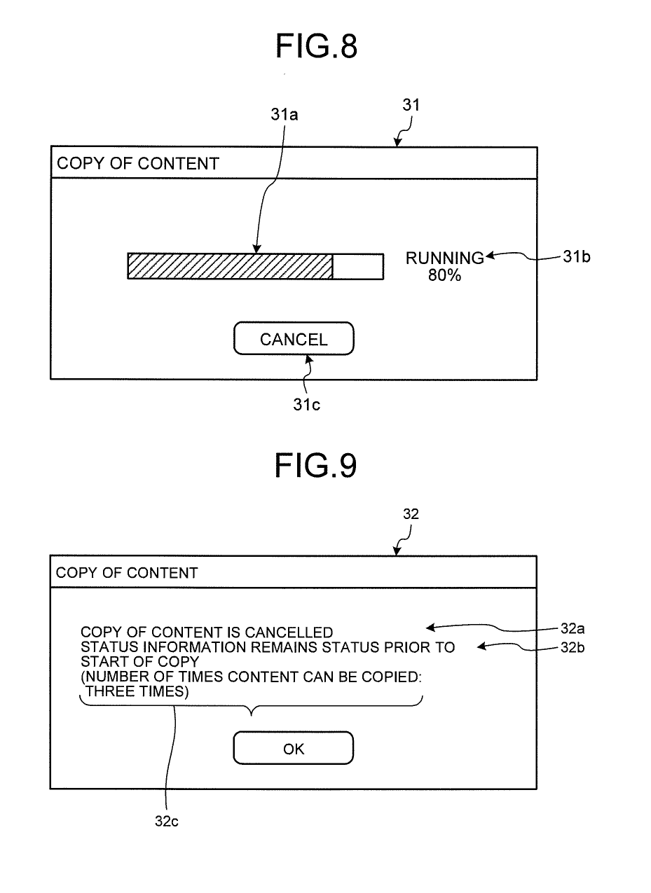

FIG. 7 is an example of a sequence diagram in the case where the processing of the content 22 is interrupted by a cancel instruction from the user. FIG. 8 is a diagram illustrating an example of information (image) 31 displayed on the display screen (not illustrated) of the display 3 while the processing of the content 22 (copy (replication) in the example of FIG. 8) is being performed. As illustrated in FIG. 8, the output controller 42 controls the display controller 10 such that the information 31 is displayed on the display 3 during the processing of the content 22. In the example of FIG. 8, the information 31 contains a bar (progress bar, or image) 31a indicating the progress of the processing of the content 22, a value of the progress (figures, characters, or a sentence, which is “80%” in the example of FIG. 8) 31b, and a button (image) 31c capable of instructing “cancel” by a click or the like with a cursor (not illustrated) on the display screen. In this case, for example, if the operator (user) clicks the input module 8 with the cursor overlapped with the button 31c on the display screen, the input controller 43 receives a signal (data) corresponding to the click via the input module controller 11, and transmits a signal (data) that instructs interruption of the processing of the content to the content processor 41. In this case, the content processor 41 interrupts the processing of the content 22.

FIG. 9 is a diagram illustrating an example of information (image) 32 displayed on the display screen of the display 3 after the processing of the content 22 is cancelled. As illustrated in FIG. 9, the third controller 40c of the security module 40 controls the display controller 10 such that the information 32 is displayed on the display 3 when the processing of the content 22 is terminated by an instruction of cancel. In the example illustrated in FIG. 9, the information 32 contains information (characters, a sentence, or an image) 32a indicating that the processing of the content 22 is cancelled, information (characters, a sentence, or an image) 32b indicating that the status information (control information) is not changed because of the cancel (an aspect of the abnormal termination) of the processing of the content 22, information (characters, a sentence, or an image) 32c indicating the status information (control information, which is the number of times the content 22 can be copied of “three times” in the example of FIG. 9), and other information. The information 32b and 32c is an example of third information.

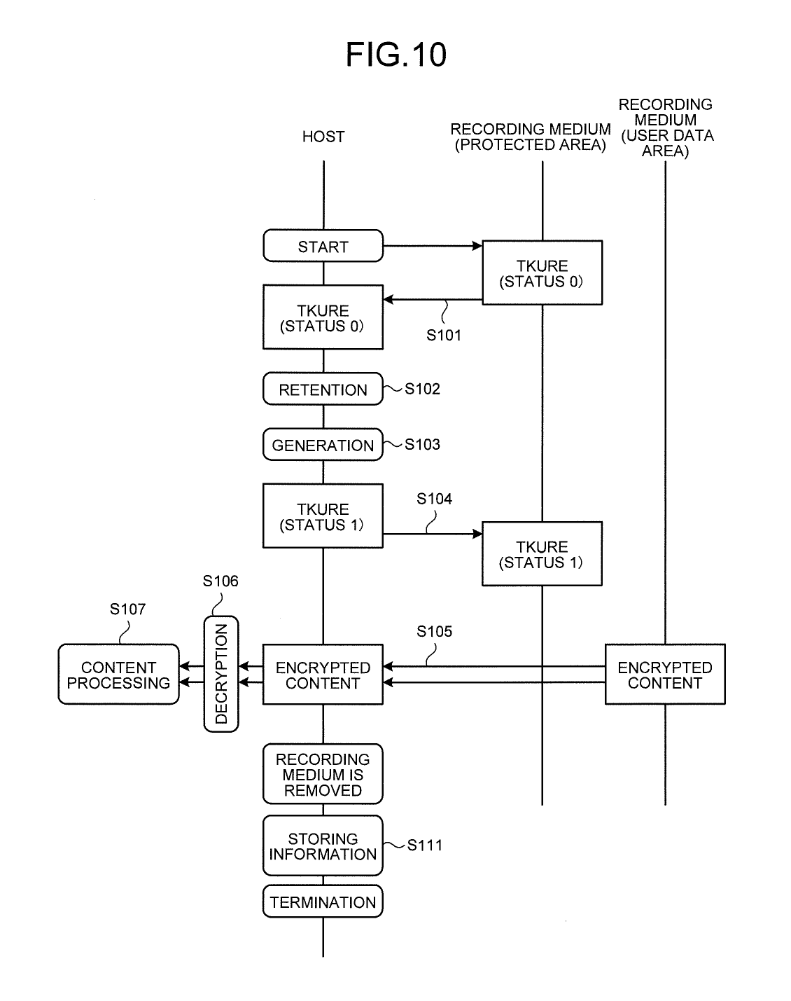

FIG. 10 is a sequence diagram in the case where the processing of the content 22 is interrupted because the recording medium 2 is removed from the connector 12 during the processing of the content 22. If the processing at S109 in FIG. 5 is not performed (fails to be performed), that is, if the control information of the UR 21b in the data 21 corresponding to the content 22 to be processed fails to be changed from the control information of “status 1” to the control information of “status 0” because of removal of the recording medium 2 from the connector 12 or other factors (No at S110), the fourth controller 40d of the security module 40 stores information required for recovery in a memory so as to recover the control information when the recording medium 2 can be accessed thereafter (S111). The information required for the recovery at S111 is identification information (media ID) that identifies the recording medium 2 and information indicating the processing of the content 22 that is abnormally terminated (an example of fourth information). The information indicating the processing of the content 22 that is abnormally terminated includes the identification information of the content 22, the identification information of the processing of the content 22, and the control information (before the processing and posterior to the processing). The memory that stores therein the information required for the recovery is a nonvolatile rewritable memory, and is the HDD 7, for example. Alternatively, a nonvolatile rewritable memory 94 that stores therein the information required for the recovery may be provided to the recording medium controller 9 as illustrated in FIG. 2, or to another portion in the electronic device 1.

Furthermore, it is preferable that the identification information of the recording medium 2 and the information required for the recovery be stored in the memory in a manner encrypted. Specifically, for example, the encryption/decryption module 92 can encrypt the identification information of the recording medium 2 and the information required for the recovery. Furthermore, data to which only the electronic device 1 (security module 40) can access is preferably used as the cryptographic key in this case.

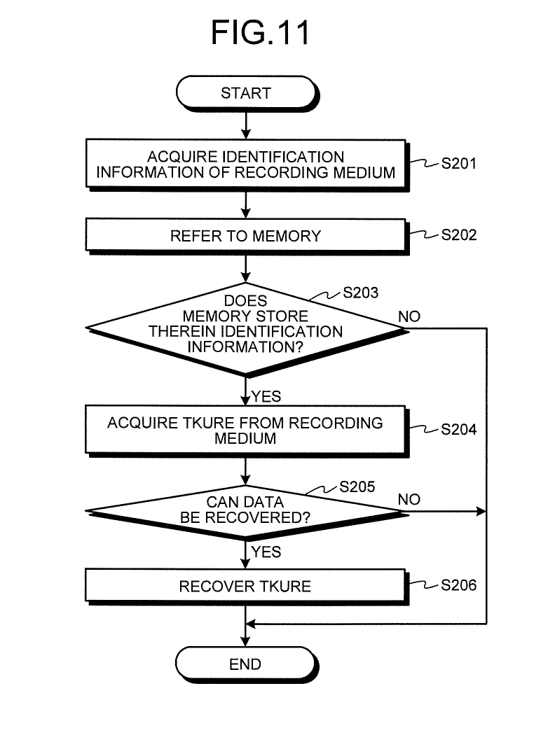

The recovery processing can be performed in accordance with the flow illustrated in FIG. 11, for example. The recovery processing illustrated in FIG. 11 can be performed after the recording medium 2 is connected and the mutual authentication process is performed, and before the processing of the content 22 is started. The security module 40 acquires the identification information of the recording medium 2 stored in the protected area 2a via the protected area I/F 90 (S201). Furthermore, the security module 40 refers to the memory (memory that stores therein the identification information and the information indicating the processing of the content 22 that is abnormally terminated, such as the HDD 7 and the memory 94) (S202). If the memory does not store therein the identification information of the recording medium 2 or the information indicating the processing of the content 22 that is abnormally terminated (No at S203), the recovery processing is terminated.

By contrast, if the memory stores therein the identification information of the recording medium 2 or the information indicating the processing of the content 22 that is abnormally terminated (Yes at S203), the security module 40 acquires the data (TKURE) 21 via the protected area I/F 90 (S204). The determination module 40f of the security module 40 then compares the data 21 acquired from the recording medium 2 with the information indicating the processing of the content 22 that has been stored in the memory, and determines whether the data 21 can be recovered, that is, whether the data 21 is to be recovered (S205). At S205, if the control information of the content 22 that has been stored in the memory is identical to the control information of the content 22 corresponding thereto acquired from the recording medium 2 (if, after the processing of the content 22 is abnormally terminated, the processing of the content 22 is not performed in other electronic devices (not illustrated) and the like, and the recording medium 2 is electrically connected to the electronic device 1 in which the abnormal termination occurs), for example, the determination module 40f can determine that the recovery can be performed (recovery is to be performed). Alternatively, regardless of whether the content 22 is used in other electronic devices, if the content 22 to be the target is left in the recording medium 2, the control information can be recovered. Furthermore, a temporal restriction can be set for the recovery of the status information (control information or data 21). Specifically, for example, the security module 40 stores therein information indicating time at which the processing of the content 22 is abnormally terminated in the memory as the information indicating the processing of the content 22. If difference between the time of the abnormal termination and the current time is equal to or larger than a predetermined threshold value, the determination module 40f determines that the recovery cannot be performed (recovery is not to be performed).

If the determination module 40f determines that the recovery cannot be performed (recovery is not to be performed) at S205 (No at S205), the processing is terminated. By contrast, if the determination module 40f determines that the recovery can be performed (recovery is to be performed) at S205 (Yes at S205), the fifth controller 40e of the security module 40 recovers the control information of the data 21 in the recording medium 2 (S206). At S206, specifically, if the number of times the content 22 can be reproduced is “4” in the control information determined to be information that can be recovered (that is to be recovered) in terms of reproduction in the recording medium 2, for example, the number of times of the abnormal termination (once) is returned thereto (for example, the number of times is counted up in this case). Thus, it is possible to recover (change) the number of times the content 22 can be reproduced to “5”.

As described above, the electronic device 1 according to the present embodiment comprises the first controller 40a and the second controller 40b. Before the content processor 41 terminates the processing of the content 22, the first controller 40a performs control such that the data 21 (UR 21b of the TKURE or status information) recorded in the recording medium 2 is changed from the control information of “status 0” (first information) indicating the processing status before the start of the processing performed by the content processor 41 to the control information of “status 1” (second information) indicating the processing status after the termination of the processing performed by the content processor 41. If the processing of the content 22 performed by the content processor 41 is not normally terminated, the second controller 40b performs control such that the data 21 is changed from the second information to the first information. Therefore, according to the present embodiment, both in the case where some kind of abnormality occurs after the termination of the processing of the content 22, and the case where some kind of abnormality occurs during the processing of the content 22, for example, the information (status information, control information, or data (TKURE) 21) indicating the status of the processing of the content 22 recorded in the recording medium 2 can indicate an actual status of the processing more accurately.

The electronic device 1 according to the present embodiment comprises the memory (information storage). The memory (information storage) retains the control information of “status 0” (first information) indicating the processing status before the start of the processing performed by the content processor 41 at least during the processing of the content 22 performed by the content processor 41. Accordingly, even if the processing of the content 22 is abnormally terminated, for example, the configuration facilitates changing the information (status information) indicating the status of the processing of the content 22 recorded in the recording medium 2 from the control information of “status 1” (second information) to the control information of “status 0” (first information) thus retained. The control information of “status 1” (second information) indicates the processing status after the termination of the processing performed by the content processor 41.

The electronic device 1 according to the present embodiment comprises the third controller 40c. The third controller 40c performs control such that the display 3 displays the information 32b and 32c (third information) if the information (status information) indicating the status of the processing of the content 22 recorded in the recording medium 2 is changed from the control information of “status 1” (second information) to the control information of “status 0” (first information). The information 32b and 32c (third information) indicates that (the value of) the processing status of the content 22 in the data 21 (UR 21b of the TKURE or status information) recorded in the recording medium 2 remains unchanged (is not changed). Accordingly, for example, the operator (user) can recognize in a simpler manner the fact that the control information is not changed if the processing of the content 22 performed by the content processor 41 is abnormally terminated.

The electronic device 1 according to the present embodiment comprises the fourth controller 40d. The fourth controller 40d performs control such that the memory stores therein at least the identification information of the recording medium 2 and information (fourth information) indicating the processing of the content 22 that is not terminated if the processing of the content 22 performed by the content processor 41 is not normally terminated, and if the information (status information) indicating the status of the processing of the content 22 recorded in the recording medium 2 is not changed from the control information of “status 1” (second information) to the control information of “status 0” (first information). Furthermore, the electronic device 1 according to the present embodiment comprises the fifth controller 40e. The fifth controller 40e performs control such that information (status information) indicating the status of the processing recorded in the recording medium 2 corresponding to the identification information is restored into information corresponding to the processing status before the start of the processing of the content 22 corresponding to the fourth information if the memory stores therein at least the identification information of the recording medium 2 and the fourth information corresponding to the identification information. Accordingly, if the processing of the content 22 is not normally terminated, and if the status information fails to be changed from the control information of “status 1” (second information) to the control information of “status 0” (first information), for example, it is possible to recover properly the information (status information) indicating the status of the processing of the content 22 recorded in the recording medium 2 based on the information stored in the memory by the fourth controller 40d when the electronic device 1 and the recording medium 2 are connected thereafter.

The electronic device 1 according to the present embodiment comprises the determination module 40f. The determination module 40f compares the information (fourth information) indicating the processing of the content 22 that is not terminated with the information (status information) indicating the status of the processing of the content 22 recorded in the recording medium 2, and determines whether the control by the fifth controller 40e is performed. Accordingly, for example, it is possible to put restrictions (conditions to perform the recovery) on the information (status information) indicating the status of the processing of the content 22 recorded in the recording medium 2.

In the electronic device 1 according to the present embodiment, the identification information of the recording medium 2 and the information (fourth information) indicating the processing of the content 22 that is not terminated are encrypted to be stored in the memory. Accordingly, for example, it is possible to prevent a trouble from occurring because of some kind of operation (access) to the identification information or the fourth information.

While a certain embodiment has been described, the present embodiment has been presented by way of example only, and are not intended to limit the scope of the inventions. Indeed, the novel device and method described herein may be embodied in a variety of other forms. In the present embodiment, reproduction or replication (copy) of the content is exemplified as the processing of the content. However, even in the case where other processing (e.g., movement and deletion) is performed on the content, the processing can be performed in the similar manner with the similar configuration.

Furthermore, specs (such as a structure, a type, the number, and an arrangement) of the electronic device, the recording medium, the information storage, the display, the memory, the connector, and the like can be changed arbitrarily to be embodied.

According to the present embodiment, for example, it is possible to provide an electronic device and an information processing method that allow information indicating a status of processing of content to indicate an actual status of the processing more accurately.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a content processor configured to process content recorded in a recording medium;
a first controller configured to, before the content processor terminates processing of the content, perform control such that status information indicating a processing status of the content recorded in the recording medium is changed from first information indicating a processing status of the content before start of the processing performed by the content processor to second information indicating a processing status of the content after termination of the processing performed by the content processor; and
a second controller configured to, when the processing of the content performed by the content processor is not normally terminated, perform control such that the status information is changed from the second information to the first information.

2. The electronic device of claim 1, further comprising an information storage configured to retain the first information at least during the processing of the content performed by the content processor.

3. The electronic device of claim 1, further comprising a third controller configured to, when the status information is changed from the second information to the first information, control a display to display third information indicating that the processing status of the content in the status information remains unchanged.

4. The electronic device of claim 1, further comprising a fourth controller configured to, when the processing of the content performed by the content processor is not normally terminated, and if the status information is not changed from the second information to the first information, control a memory to store therein at least identification information of the recording medium and fourth information indicating the processing of the content that is not terminated.

5. The electronic device of claim 4, further comprising a fifth controller configured to, when the memory stores therein at least the identification information and the fourth information corresponding to the identification information, perform control such that the status information of the recording medium corresponding to the identification information is changed to information corresponding to the processing status before the start of the processing of the content corresponding to the fourth information.

6. The electronic device of claim 5, further comprising a determination module configured to compare the fourth information with the status information of the recording medium to determine whether control by the fifth controller is performed.

7. The electronic device of claim 4, further comprising:
an encryption processor configured to encrypt the identification information and the fourth information, wherein
the fourth controller is configured to control the memory to store therein the identification information and the fourth information encrypted by the encryption processor.

8. An information processing method comprising;
processing content recorded in a recording medium;
changing, before the processing of the content is terminated, status information indicating a processing status of the content recorded in the recording medium from first information indicating a processing status of the content before start of the processing of the content to second information indicating a processing status of the content after termination of the processing of the content; and
performing control, when the processing of the content is not normally terminated, such that the status information is changed from the second information to the first information.
